(19) United States
(12) Patent Application Publication
(10) Pub. No.: US 2008/0244495 A1
(43) Pub. Date: Oct. 2, 2008

(54) METHOD OF DETERMINING WIRE PATTERN ON BOARD AND BOARD DESIGNED BY THE METHOD

(75) Inventor: Yoji KAJITANI, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Shwu-Jen WANG, Tokyo (JP)

(21) Appl. No.: 12/037,418

(22) Filed: Feb. 26, 2008

(30) Foreign Application Priority Data
Mar. 27, 2007 (JP) 2007-82600

(51) Int. Cl. G06F 17/50

(52) U.S. Cl. 716/12

(57) ABSTRACT

A method of determining a wire pattern 11 formed by a plurality of wires W1, W3-W6, W9, and W10 on a board, the method including: an area-graph constructing step of forming an area-graph 12 in the routing area 10, the area-graph 12 having pins P1-P10 and edges B1-B16 connecting the pins P1-P10; a covering-path set specifying step of positioning the pins P1, P3-P6, P9, P10 on a plurality of paths L1-L3 from a start point to an end point T which are two selected pins; a number and direction assigning step of sequentially assigning increasing numbers to the pins P1, P3-P6, P9, P10 that each of the paths L1-L3 passes, and directions to edges B1-B16; a preliminary wire segment generating step of forming a preliminary wire segment toward an area enclosed by the edges B1-B16 where the assigned directions are confluent from entry to exit sides of each of the pins P1, P3-P6, P9, P10; and a wire pattern determining step of extending the preliminary wire segments to the outside of the routing area 10 without crossing each other, thereby producing the wire pattern 11.

### BACKGROUND OF THE INVENTION

1. Field of the Invention

The present invention relates to a method of determining a wire pattern on a board and a board designed by the method.

2. Description of the Related Art

Conventional methods of determining a wire pattern on a board are classified into six categories (a) to (f) as follows according to the representation of wire pattern data to be used.

(a) A direct routing method: A wire pattern is defined in an xy-coordinate as shown in FIG. 14. (See, e.g., Japanese Unexamined Patent Application Publication No. 2001-60753)

(b) A grid-based routing method: A routing area is partitioned into a plurality of rectangular cells by vertical and horizontal lines, and a plurality of wire shapes are represented by the sequence of the cells. Fitted with each other along the sequence, the cells as a whole form a complete wire pattern. (See, e.g., Japanese Unexamined Patent Application Publication No. 2003-45973)

(c) A polygon-based routing method: The method is obtained by generalizing the above-mentioned grid-based routing method. A routing area is partitioned into arbitrary shaped polygons each being sufficiently small in size, and a wire pattern is represented by the sequence of the polygons inside which a part of the wire pattern is fixed as shown in FIG. 15. (See, e.g., Japanese Unexamined Patent Application Publication No. 2000-58549)

(d) A rubber-band routing method: Wires are regarded as elastic rubber bands stretched between nails (usually signal pins) positioned in a routing area. The stretched wires are regarded as straight lines, and a wire pattern is represented by the sequence of the nails connected by the straight lines as shown in FIG. 16. The method aims at reduction of the data amount of the wire pattern.

(e) A monotonic routing method: A wire pattern is determined under conditions that directions of wires are downward and monotonic, that is, no wires are upward in any cells. In particular, wires are extended from “n” pieces of pin arrays placed on the top of a routing area where “n” pieces of pins are arranged in a matrix as shown in FIG. 17. Natural numbers from 1 to “n” are monotonously assigned to the pins such that the numbers increase in the right and downward directions. One of the wires extended from a corresponding one of the pin arrays, e.g., the k-th wire from the left is extended so as to pass between the numbered pins in a matrix arrangement whose numbers contain the number “k” therebetween. The number (density) of the wires passing between two pins is less than or equal to the difference of the numbers of the two pins.

(f) A flow-network based method: Each wire is considered as a flow of a specific substance, and a routing area is represented by a flow network where each pair of adjacent pins defines its flow capacity. The known Maxflow-Mincut algorithm is used to check if an overall wire pattern satisfies the wire separation rule. The feature of the method is that all the wires can be determined simultaneously.

According to the first five methods among the six methods, however, preceding wires become obstacles to succeeding ones because a single wire is completed at a time. Thus, these six methods have a defect that routability of all wires depends on the routing order (the direct routing method, grid-based routing method, and polygon-based routing method), the presence of strict limits such as monotonicity (the monotonic routing method), and the presence of frequent observations (the rubber-band routing method, flow-network based method). The flow-network based method is able to determine the routes of all the wires simultaneously, but is disadvantageous in that the calculation of graph structures and maximum flows is enormous in amount and indirect, and thereby influence of changes of the routing is not easily reflected.

As mentioned above, the conventional methods can determine wire patterns only if the problems are very small in degree or if the wire patterns are designed under the very strict constraint. Thus, the conventional methods are not practical.

Accordingly, effective methods have not been provided which are capable of determining the wire pattern having the plurality of wires on the board.

### SUMMARY OF THE INVENTION

The present invention has been made in view of the above circumstances, and thus the object of the present invention is to provide a method of determining a wire pattern on a board and a board designed by the method. The method is capable of designing a wire pattern, estimating the congestion degrees of the wire pattern on a board, determining routes of all wires simultaneously, and realizing greater design freedom without using wire diagrams.

To accomplish the above object, in a first aspect, the present invention provides a method of determining a wire pattern on a board, the wire pattern defined in a routing area, a plurality of pins (also referred to as signal pins) provided in a plane in the routing area, the wire pattern formed of wires (also referred to as 1-pin nets) each extended from its corresponding one of the pins, each 1-pin net (1) passing through one of the pins, (2) being out of contact with any other wires, and (3) having both ends provided in the outside of the routing area, the method comprising:
an area-graph constructing step of forming an area-graph in the routing area where the wire pattern is to be defined, the area-graph having a group of the plurality of pins (existing pins and at least one additional pin added if required) and a group of edges each connecting a pair of adjacent pins without crossing any other edges;
a covering-path set specifying step of selecting two reference pins facing the outside of the area-graph from the plurality of pins as a start point (source) S and an end point (sink) T, and forming a group of a plurality of paths, each path extending from the start point to the end point such that all the pins except the two reference pins are included in any of the paths;
a number and direction assigning step of respectively assigning distinct numbers (potentials) to all the pins such that each path increases in pin number from the start point S to the end point T, and subsequently assigning each edge a direction from the smaller to the larger numbers of the pins provided at the both ends of each edge, thereby obtaining a directed graph called a potential graph;
a preliminary wire segment generating step of, if each of the pins except the two reference pins is in contact with two areas (faces), each area including the edges having incoming and outgoing directions with respect to each pin except the two reference pins, for example, defining the two areas as confluent areas (faces) for each pin except the two reference pins, and disposing both ends of a preliminary wire segment extended from each pin except the two reference pins in the confluent faces, respectively;
a wire pattern determining step of extending the both ends of each preliminary wire segment to the outside of the routing area without crossing any other preliminary wire segments according to a rule that each preliminary wire segment passes the edges each having two numbered pins one at each end thereof, the numbers of the two numbered pins defining a numerical interval, the numerical interval including the number of the pin on the preliminary wire segment, and completing “n−2” pieces of the wires in total where “n” is the total number of the existing pins, thereby producing the wire pattern.

To accomplish the above object, in a second aspect, the present invention provides a board designed by the method according to the first aspect of the present invention.

According to the method and the board of the present invention, the potential graph is formed in the routing area where the wire pattern is to be defined, and the wire pattern where the plurality of wires do not cross each other is determined by batch processing. The area-graph constructing step is to form the area-graph, i.e., a virtual area which includes the group of the plurality of pins (usually signal terminals) and the group of the edges connecting the adjacent pins. Thus, the wire pattern and the whole routing area defining the wire pattern are simulated using a single graph, whereby the data amount used for wiring is drastically reduced compared with those in conventional methods. In the number and direction assigning step, the potentials in the form of numbers are assigned to the pins. Thus, the number of the wires which cross each edge is less than or equal to the difference of the numbers of the two pins provided at both sides of each edge. Accordingly, simply changing the numbers of the pins enables controlling of the density of the wires, whereby the less data is processed faster than before. Thus, design and evaluation of the wire pattern are possible without the use of the wire diagrams, and design freedom is increased compared to the conventional methods.

According to the method of the first aspect of the present invention, it is preferable that the covering-path set specifying step and the number and direction assigning step are replaced with a source/sink nonproductive step so as not to produce any more pins for the start point S and the end point T other than the pins previously set as the start point S and the end point T. The source/sink nonproductive step is to assign the numbers “1” and “n” to the two selected pins, i.e., the start point S and the end point T respectively, and then to assign the other numbers 2, 3, . . . , k (k=2, 3, . . . , n−1) to all the pins except the two selected pins in accordance with partial connectivity which is a rule that the set of pins from 2 to “k” form a connected subgraph of the potential graph and so does the set of pins from “k+1” to “n.” In this instance, the direction is given to each of the edges from the smaller to the larger numbers of the pins. Subsequently, the preliminary wire segment generating step and the wire pattern determining step are performed in sequence.

According to the method of the first aspect of the present invention, it is preferable that the routes of any one or more of the wires obtained in the wire pattern determining step are altered by (i) changing the paths in the covering-path set specifying step, and (ii) carrying out the number and direction assigning step, the preliminary wire segment generating step, and the wire pattern determining step in sequence. Thus, the wire pattern can be altered by a simple operation without a drastic design change.

According to the method of the first aspect of the present invention, it is preferable that the routes of any one or more of the wires obtained in the wire pattern determining step are altered by adding a pin in the area-graph constructing step thereby to set the greater number of pins than that of the wires, and changing the numbers assigned to the pins, thereby changing the wire pattern. In this manner, the wire pattern can be altered by a simple operation without a drastic design change.

### BRIEF DESCRIPTION OF THE DRAWINGS

FIG. 1 is a descriptive illustration of a routing area used for a method of determining a wire pattern on a board in accordance with one embodiment of the present invention.

FIG. 2 is a descriptive illustration of an area-graph formed in an area-graph constructing step in the method.

FIG. 3 is a descriptive illustration of three paths formed in a covering-path set specifying step in the method.

FIG. 4 is a descriptive illustration of two paths formed in the covering-path set specifying step in the method.

FIG. 5 is a descriptive illustration of a potential graph obtained by number assignment in a number and direction assigning step based on the three paths formed in the covering-path set specifying step in the method.

FIG. 6 is a descriptive illustration of another potential graph obtained by number assignment in the number and direction assigning step based on the three paths formed in the covering-path set specifying step in the method.

FIG. 7 is a descriptive illustration illustrating that each pin has two areas where directions given to edges are confluent from an entry side to an exit side of each pin in the potential graph obtained by the number and direction assigning step in the method.

FIG. 8 is a descriptive illustration of a preliminary wire segment generating step in the method.

FIG. 9 is a descriptive illustration of a preliminary wire segment generating step in the method.

FIG. 10 illustrates both ends of a pin P6 reaching the outside of the routing area in a wire pattern determining step in the method.

FIG. 11 is a descriptive illustration of a wire pattern determined in the wire pattern determining step in the method.

FIG. 12 is a descriptive illustration of a wire pattern where a number of a pin P8 is changed in order to reduce wire congestion between pins P5 and P8 determined in the wire pattern determining step.

FIG. 13 is a descriptive illustration of a wire pattern where the numbers of the pins P5 and P6 have been changed in order to reduce wire congestion between pins P3 and P6 determined in the wire pattern determining step.

FIG. 14 is a descriptive illustration of a prior art direct routing method.

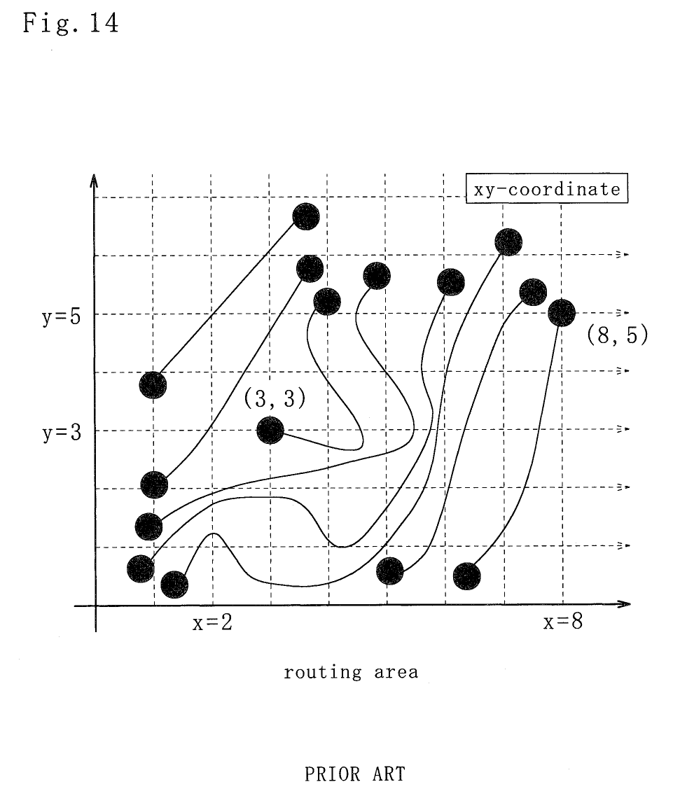

FIG. 15 is a descriptive illustration of a prior art polygon-based routing method.

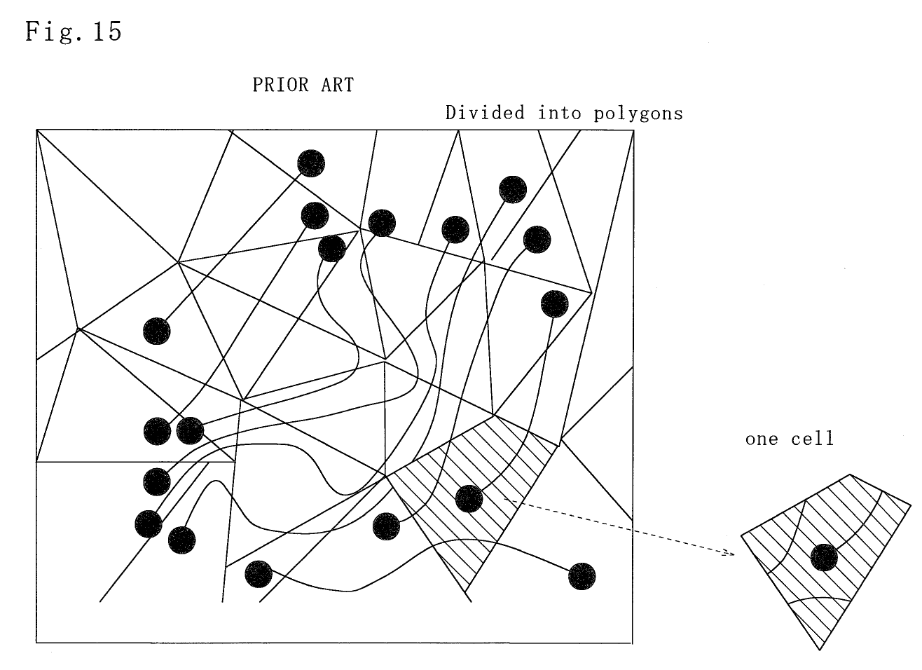

FIG. 16 is a descriptive illustration of a prior art rubber-band routing method.

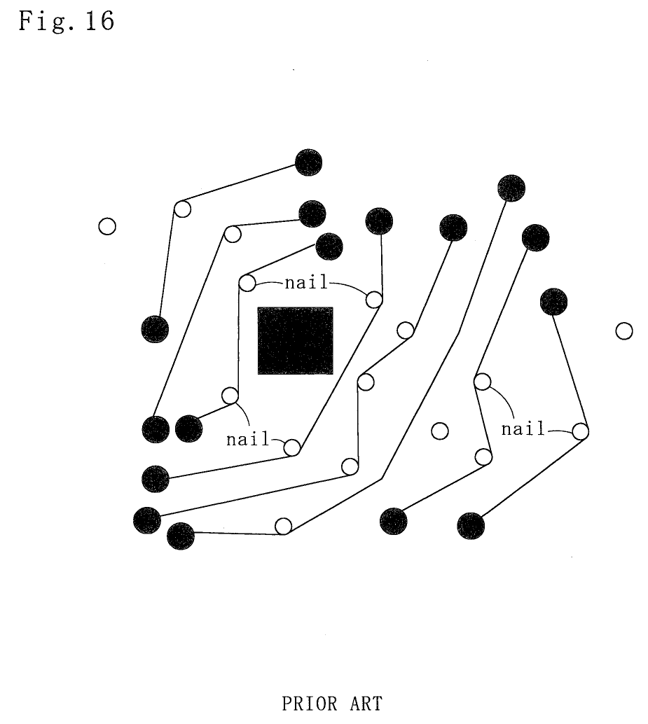

FIG. 17 is a descriptive illustration of a prior art monotonic routing method.

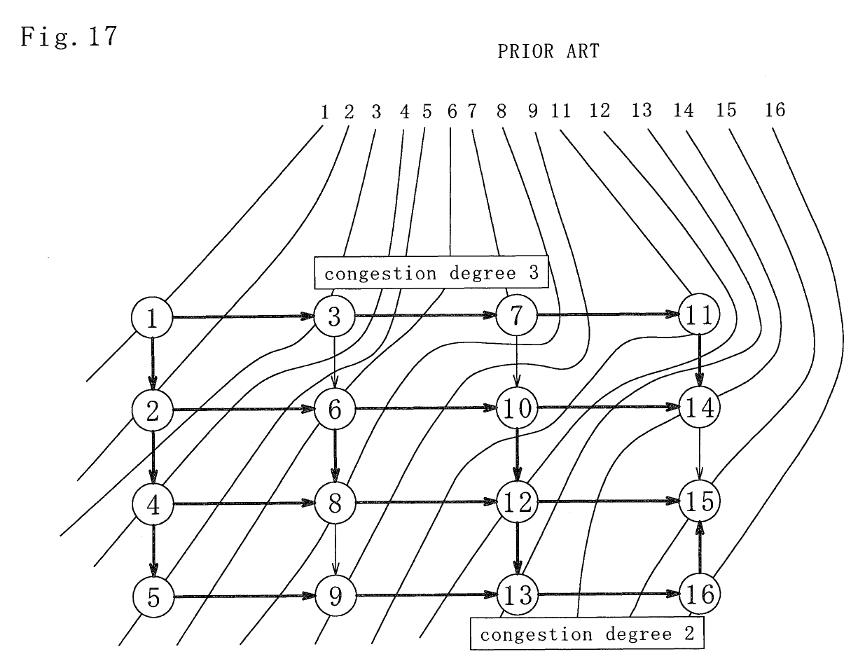

### DESCRIPTION OF THE PREFERRED EMBODIMENTS

Referring now to the accompanying drawings, an embodiment of the present invention is described for understanding of the present invention.

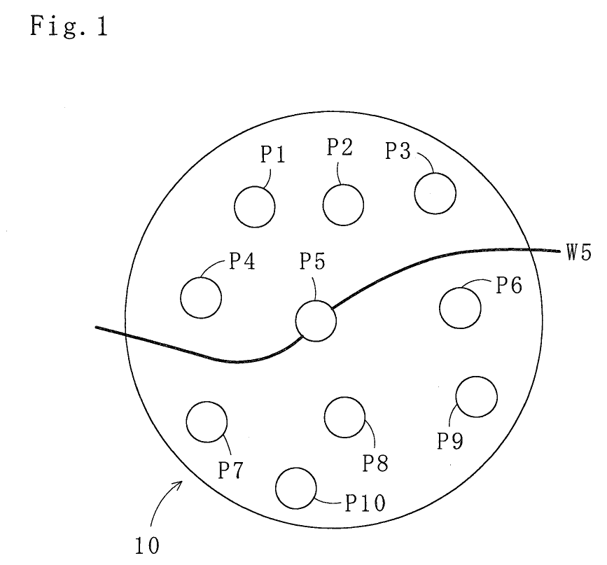

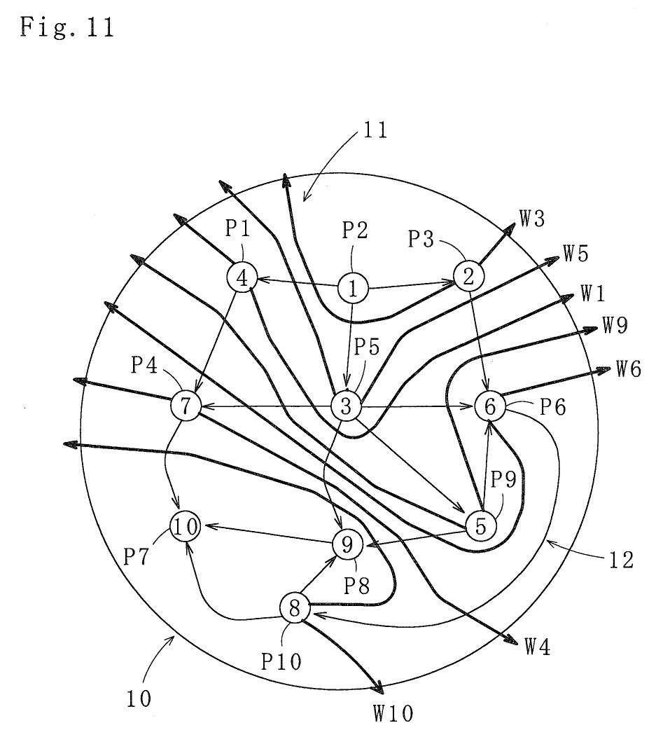

As shown in FIGS. 1-9, a method of determining a wire pattern on a board in accordance with one embodiment of the present invention is to form a wire pattern 11 (see FIG. 11) on a board such as a semiconductor device (not shown). The wire pattern 11 has pins P1-P10 in a routing area 10, and is formed of seven wires W1, W3-W6, W9 and W10 (each wire also referred to as a 1-pin net) respectively passing through the seven designated pins P1, P3-P6, P9, and P10. In the embodiment of the present invention, the method of determining a wire pattern on a board is executed using a device for fixing a wire pattern on a board (also simply referred to as a fixing device). The fixing device includes an area-graph constructing means, a covering-path set specifying means, a number and direction assigning means, a source/sink nonproductive means, a preliminary wire segment generating means, a wire pattern determining means, and a storage means. These means are controlled by, for example, a program installed in a computer. Furthermore, the fixing device is connectable to a controller of a device (not shown) for fixing wires geographically, and controllable based on conditions input by an operator using input devices such as a keyboard and a mouse.

As shown in FIG. 1, to set the routing area 10 and the pins P1-P10 therein by the area-graph constructing means, the routing area 10 and the pins P1-P10 are input and stored in the storage means. The pins P1, P3-6, P9, and P10, i.e., all the pins except the pins P2, P7, and P8 respectively serving as a start point S (source), an end point T (sink), and an added pin (also referred to as an additional pin) are used to form the wire pattern 11. Each of the wires W1, W3-W6, W9, and W10 included in the wire pattern 11 passes through one of the pins P1, P3-6, P9, and P10 without crossing any other wires. The wires W1, W3-W6, W9, and W10 have the both ends provided in the outside of the routing area 10.

The number of the pins (3-100 for example, and 10 in the embodiment) is set to be equal to or greater than the number of the wires (7 in the embodiment).

FIG. 1 illustrates an example of the wire W5 passing through the pin P5. FIGS. 11-13 illustrate the entire wire patterns.

Since the pin P8 is the added pin, no wires pass through the pin P8 in the same manner as the above plurality of pins. Likewise, since the pins P2, P7 are the start point S and the end point T respectively, no wires pass through the pin P2 or P7.

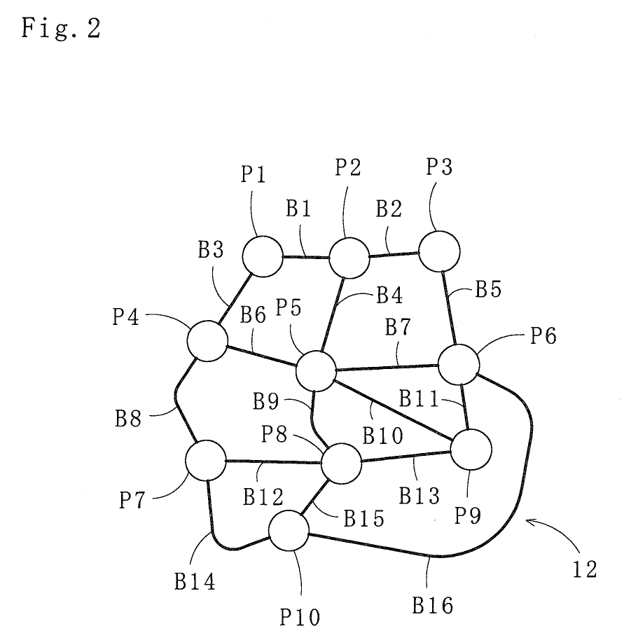

As shown in FIG. 2, edges B1-B16 which mutually connect adjacent pins among the pins P1-P10 are input, and stored in the storage means. The shape of the edges and space therebetween are not limited as long as the edges do not intersect each other. In this manner, an area-graph (virtual area) 12 formed of the pins P1-P10 and the edges B1-B16 is constructed in the routing area 10. (area-graph constructing step)

As shown in FIG. 2, using the covering-path set specifying means, two arbitrary pins facing the outside of the area-graph 12, i.e., the pins P2, P7 in this embodiment, are chosen from the ten pins P1-P10, and then the pins P2, P7 are stored in the storage means as the start point S and the end point T, respectively. The pins serving as the start point S and the end point T may be any of the pins P1, P3, P4, P6, and P10 facing the outside of the area-graph 12.

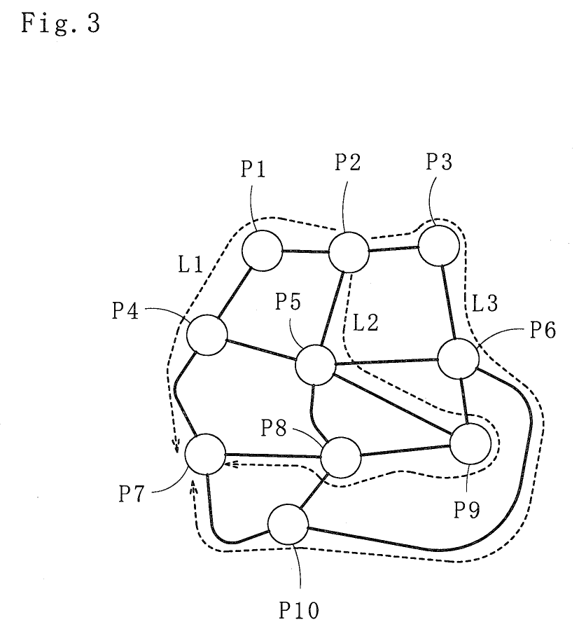

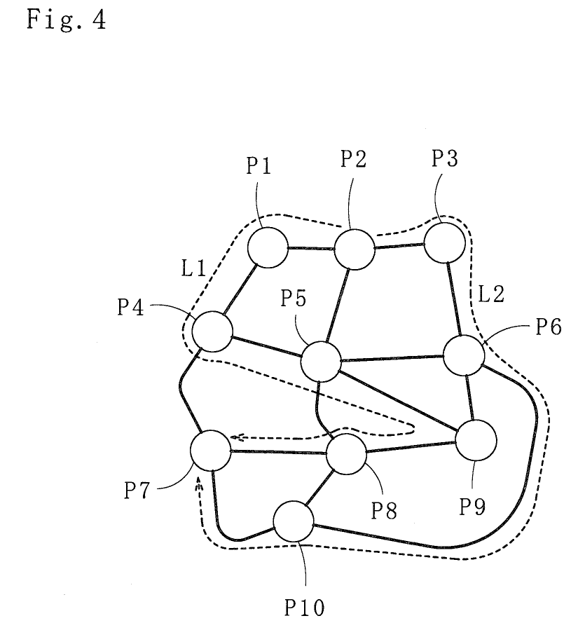

Then, a plurality of paths are formed so that the pins P1, P3-6, P8, P9, and P10, i.e., all the pins except the pin P2 (the start point S) and the pin P7 (the end point T) are located on the paths from the start point S to the end point T FIG. 3 illustrates the result (also referred to as covering-path set) of the formation of three paths L1, L2, and L3. FIG. 4 illustrates the result of the formation of two paths L1, L2. The number of the paths may be one, or four or more.

Each of the paths does not pass the same pin twice. (covering-path set specifying step)

Hereafter, producing steps are described with reference to FIG. 3.

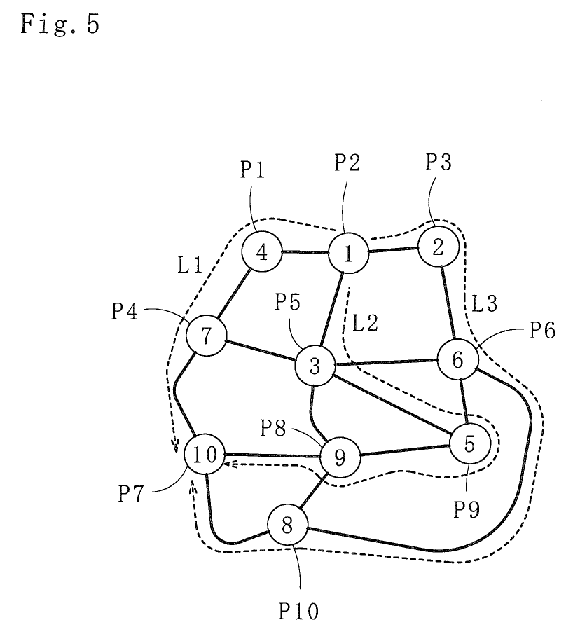

As shown in FIG. 5, using the number and direction assigning means, different numbers are assigned to all the pins P1-P10, respectively, such that the pin number in each of the paths L1, L2, and L3 increases from the start point S to the end point T. The numbers are stored in the storage means as potentials of the pins P1-P10.

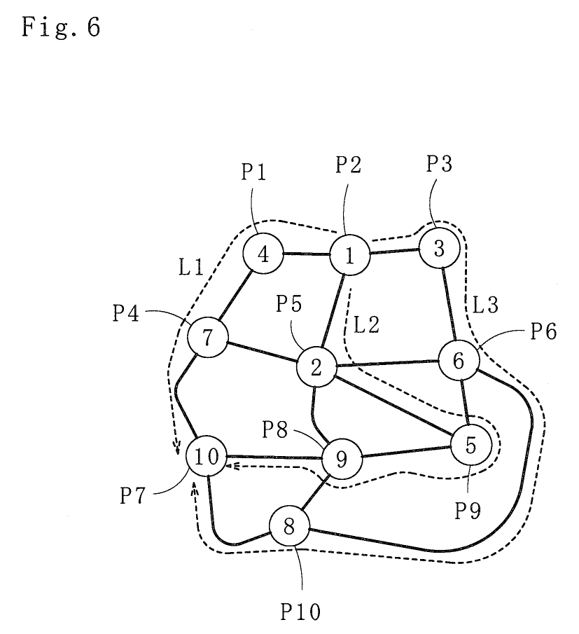

In particular, since the start point S (=P2) is the first pin for any paths of the covering-path set, the number “1” is given thereto. Likewise, since the end point T (=P7) is the last pin for any paths of the covering-path set, the number “10” which is the total number of the pins is given thereto. Next, since the pins P1, P5, and P3 are the closest to the start point S in the respective paths L1, L2, and L3, the number “2” is given to any one of these pins. FIG. 5 illustrates a potential graph where the number “2” is given to the pin P3. FIG. 6 illustrates a potential graph where the number “2” is given to the pin P5.

Referring to FIG. 5, a further explanation is given.

The closest pins to the numbered pins P2, P3 are P1 on the path L1, P5 on the path L2, and P6 on the path L3. Thus, the number “3” is assigned to one of these pins. In the present embodiment, the pin P5 is assigned the number “3.”

By repeating the above number assignment, different numbers are assigned to all the pins so that each of the paths L1-L3 is incremental in number from the start point S to the end point T.

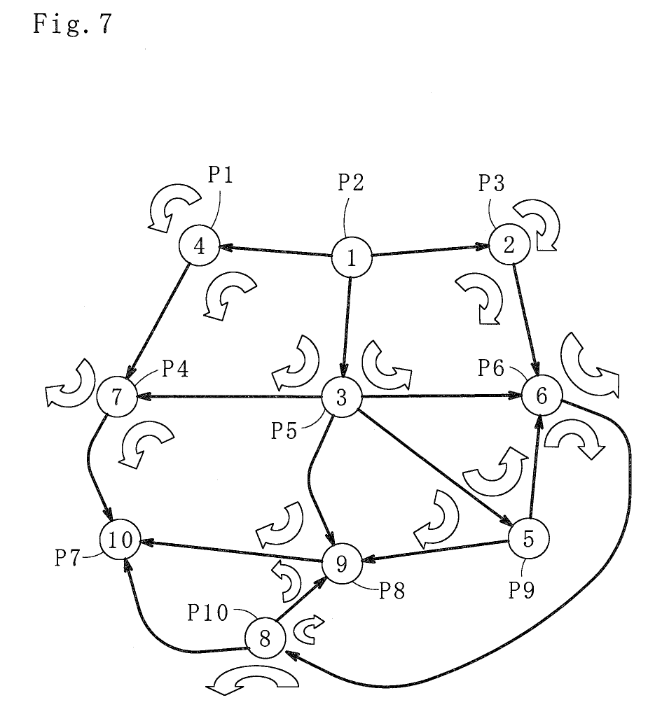

As shown in FIG. 7, directions are assigned to the edges B1-B16 in accordance with a rule that directions are assigned in ascending sequence, i.e., from the smaller to larger numbers of the pins P1-P10. The directions are stored in the storage means.

As a result, a potential graph is obtained.

The potential graph is not limited to the one obtained by the above steps, but may be altered by any of the following options:

(i) changing the reference pins serving as the start point S and the end point T
(ii) changing the numbers of the pins,
(iii) changing the paths, and
(iv) combining two or more of the above options (i)-(iii).

A choice between the potential graphs shown in FIGS. 5 and 6 is an example for the option (ii). A choice between the covering-path sets shown in FIGS. 3 and 4 is an example for the option (iii).

In accordance with the number and direction assigning step, the potential graph satisfies a property (also referred to as a bi-path property) that an area (also referred to as a face) enclosed by the pins connected by the edges is surrounded by two directional edges (also referred to as directed paths). In FIG. 7, the face is enclosed by the pins P5, P8, P7, and P4, and has a border consisting of two directed paths (P5, P8, P7) and (P5, P4, P7).

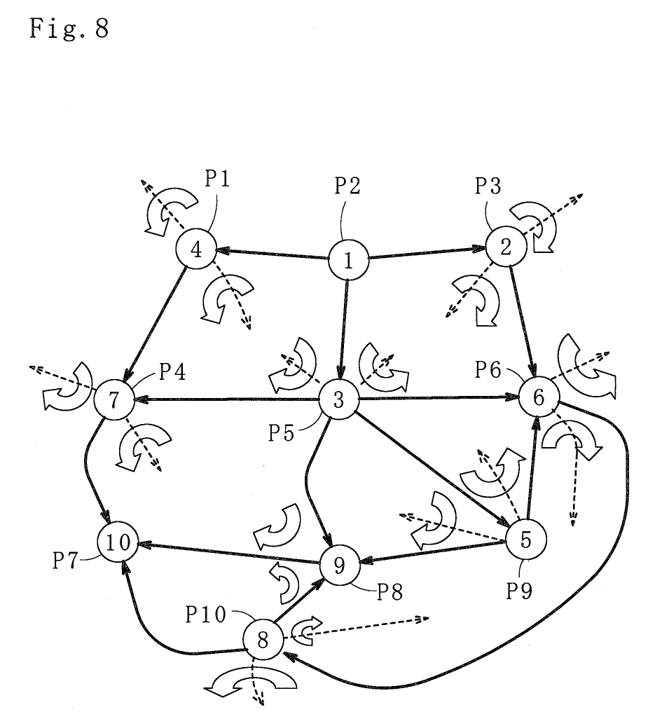

Furthermore, in accordance with the number and direction assigning step, the potential graph satisfies a bi-face property that each of the pins P1, P3-6, P9, and P10, i.e., each of all the pins except the pin P2 serving as the start point S, the pin P7 serving as the end point T and the additional pin P8 is in contact with two confluent faces each including incoming and outgoing edges with respect to each pin. FIG. 8 illustrates that the pin P5 is in contact with two confluent faces (P2, P5, P6, and P3) and (P2, P5, P4, and P1). (number and direction assigning step)

In order to obtain the potential graph, the covering-path set specifying means and the number and direction assigning means may be replaced by the source/sink nonproductive means.

The source/sink nonproductive means selects the two reference pins, i.e., the start point (one point: source) and the end point (the other point: sink) from the plurality of pins P1-P10, assigns numbers “1” and “10 (=n)” to the start point and the end point, respectively, and stores the numbers in the storage means. Next, the numbers from “2” to “9 (=n−1)” are sequentially assigned to the pins other than the reference pins serving as the start point and end point so that directions assigned to the edges B1-B16 from smaller to larger numbers the pins are both entering and leaving each of the pins other than the reference pins. Then, these numbers are stored in the storage means. In order that both incoming and outgoing directions may be assigned to each of the pins other than the reference pins, the numbers are sequentially assigned to each pin while partial connectivity is tested. The partial connectivity is a rule that the set of pins having the numbers from 2 to “k” is a connected subgraph and so is the set of pins from “k+1” to “n.”

As a result, a potential graph is obtained. (source/sink nonproductive step)

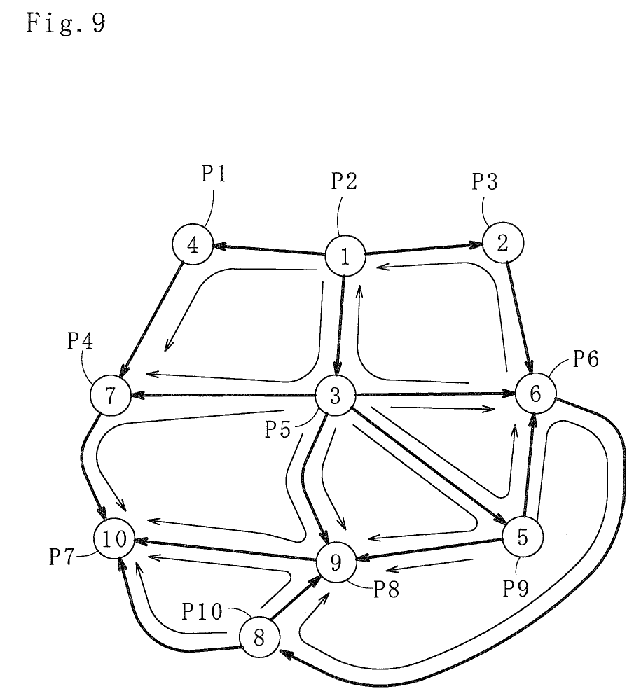

The preliminary wire segment generating means forms preliminary wire segments (indicated by dashed arrows in FIG. 8) in accordance with a first routing rule that wires are drawn from the pins P1, P3-P6, P9, and P10 to areas (two confluent faces) where the directions given to the edges B1-B16 in accordance with the bi-face property are confluent from an entry side to an exit side of each of the pins P1, P3-P6, and P8-P10 as shown in FIGS. 8 and 9. Then, the preliminary wire segments are stored in the storage means. (preliminary wire segment assigning step)

Accordingly, both ends (heads) of each of the preliminary wire segments led from the numbered pins P1, P3-P6, P9, and P10 enter two different faces. There is provided a second routing rule that, if the pin number on the extended preliminary wire segment falls within an interval defined by the pin numbers on the both sides of the edge, the end of the preliminary wire segment can cross the edge. As a result, the extension of each preliminary wire segment is uniquely determined based on the bi-face property.

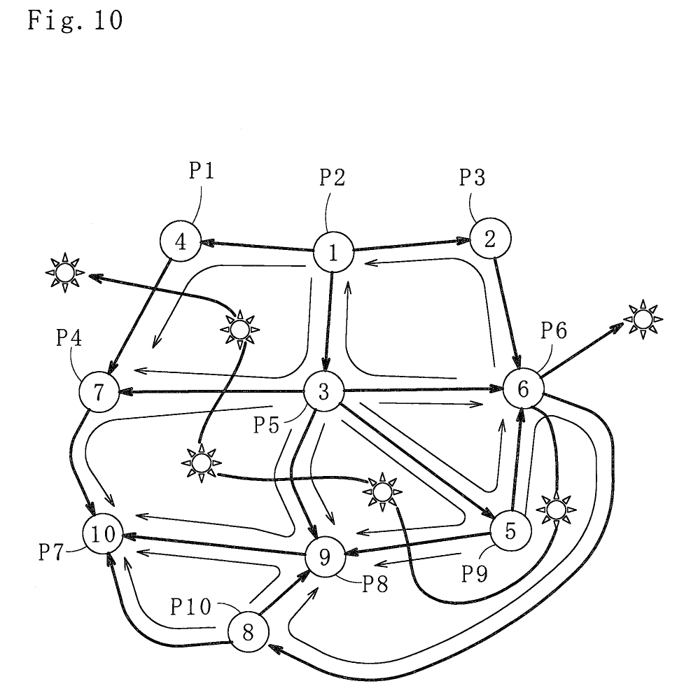

In FIG. 10, one end of the preliminary wire segment of the pin P6 with the number “6” is in the face (P9, P6, P10, and P8), and the number “6” falls between the numbers “9” and “5” of the respective pins P8 and P9. Thus, according to the second routing rule, the wire pattern determining means extends the preliminary wire segment so that the preliminary wire segment intersects the edge which connects the pins P8 and P9, and the wire pattern determining means places the preliminary wire segment in the next face (P9, P8, and P5). The edge which contains the number 6 is uniquely the edge between the number “3” of the pins P5 and the number “9” of the pin P8, and thus the preliminary wire segment is further extended so as to intersect the edge.

The other end of this preliminary wire segment is already in the outside of the routing area 10 so that no extension is necessary.

In this way, the extension of the preliminary wire segments allows each end thereof to reach the outside of the routing area through a uniquely determined sequence of faces, thereby completing the entire wire pattern. Furthermore, the above-mentioned bi-path property proves that any two wires in the same face can be extended without crossing. The wire pattern 11 formed of the complete wires W1, W3-W6, W9, and W10 passing through the respective pins P1, P3-P6, P9, and P10 is determined, and the wire pattern is stored in the storage means.

Since the whole wire pattern 11 is uniquely determined from the potential graph, the potential graph is used as the data to represent all the wires W1, W3-W6, W9, and W10.

Furthermore, each of the above steps is executed while checking the diagram displayed as a plane image on the display device. (wire pattern determining step.)

The routes of any one or more of the wires obtained in the wire pattern determining step may be altered in a manner that the conditions for constructing the potential graph are satisfied as described in the number and direction assigning step. Subsequently, the resultant potential graph is stored in the storage means.

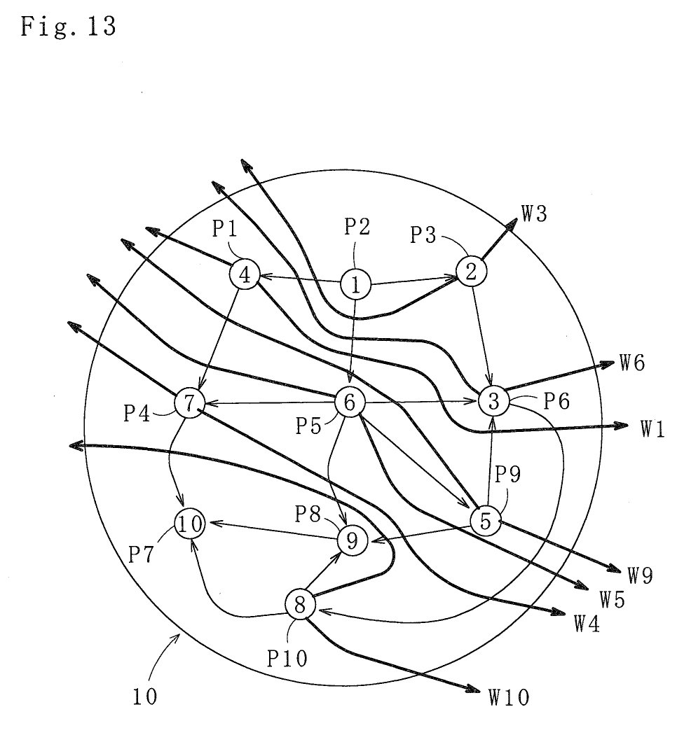

For example, one method for the alteration is to exchange the numbers of two pins while maintaining the property of the potential graph. In particular, it is confirmed that exchanging the number “3” of the pin P5 and the number “6” of the pin P6 in the potential graph in FIG. 11 does not change the property of the potential graph as shown in FIG. 13, and then the exchange of the numbers is carried out. Subsequently, new directions are assigned to the edges, and the preliminary wire segment generating step and the wire pattern determining step are performed in sequence.

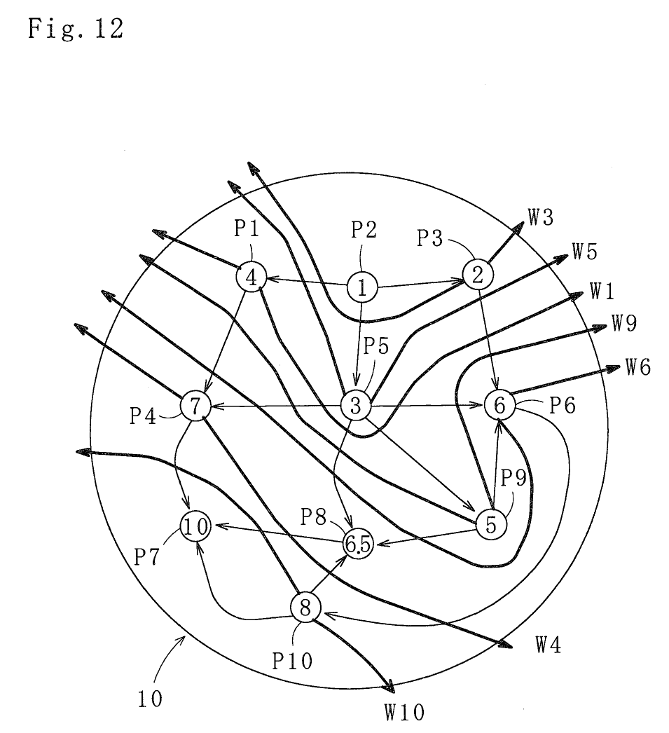

Alternatively, one or more of the wire patterns may be altered by setting a greater number of the pins than that of the wires (the pin P8 in FIG. 1 is the additional pin) in the area-graph constructing step, and by using the extra pin. In particular, as shown in FIG. 12, the number “9” of the additional pin P8 assigned in the number and direction assigning step is changed to a virtual number “6.5.” The new number is not a natural number, but represents a number between natural numbers “5” and “6.”

In accordance with the method, density distribution of the wires is improved without actual routing. Thus, design, estimation, and improvement of routing of the board are possible without actual wire routing, and the board is produced.

Although the present invention has been described with reference to the embodiment, the present invention is not limited to the above-mentioned configuration described in the embodiment. The present invention includes other embodiments and variations made without departing from the spirit and scope of the present invention. For example, the present invention includes methods of determining a wire pattern on a board and boards designed by the method made by combination of a part or all of the embodiment and variations described above.

Furthermore, the method of determining a wire pattern on a board has been described with reference to the embodiment wherein the wire pattern is designed without any previously designed wire pattern. However, the method can be also applied to variations employing previously designed wire patterns.

Furthermore, the embodiment has been described using natural numbers as the numbers given in the number and direction assigning step. However, any distinct real numbers may be used since only the magnitudes of numbers are used. For example, the number 6.5 is used to construct the potential graph shown in FIG. 12.

What is claimed is:

1. A method of determining a wire pattern on a board, the wire pattern formed of a plurality of wires, each wire passing through its corresponding one of a plurality of pins provided in a routing area without crossing any other wires, both ends of each wire provided in the outside of the routing area, the method comprising:
an area-graph constructing step of forming an area-graph in the routing area, the area-graph having the pins and edges, the number of the pins greater than or equal to that of the wires, each edge connecting the adjacent pins;
a covering-path set specifying step of selecting two reference pins from the pins as a start point and an end point, and forming a plurality of paths, each path extending from the start point to the end point such that all the pins except the two reference pins are included in any of the paths;
a number and direction assigning step of respectively assigning distinct numbers to all the pins such that each path increases in pin number from the start point to the end point, and assigning each edge a direction from the smaller to the larger numbers of the pins;
a preliminary wire segment generating step of extending a preliminary wire segment from each of all the pins except the two reference pins to areas having the edges, the directions of the edges being confluent from an entry side to an exit side of each of all the pins except the two reference pins; and
a wire pattern determining step of extending both ends of each preliminary wire segment to the outside of the routing area without crossing any other preliminary wire segments according to a rule that each preliminary wire segment passes the edges each having two numbered pins one at each end thereof, the numbers of the two numbered pins defining an interval, the interval including the number of the pin on the preliminary wire segment, thereby producing the wire pattern.

2. The method of determining a wire pattern on a board as defined in claim 1, wherein the covering-path set specifying step and the number and direction assigning step are replaced with a source/sink nonproductive step, the source/sink nonproductive step comprising (i) selecting two reference pins from the plurality of pins, (ii) assigning numbers “1” and “n” to the two reference pins, respectively, and (iii) assigning numbers ranging from “2” to “n−1” in sequence to all the pins except the two reference pins so that directions to be assigned to the edges from the smaller to larger numbers of the pins are both incoming and outgoing directions with respect to each of all the pins except the two reference pins; and then the preliminary wire segment generating step and the wire pattern determining step are carried out in sequence.

3. The method of determining a wire pattern on a board as defined in claim 1, wherein the routes of any one or more of the wires obtained in the wire pattern determining step are altered by (i) changing the paths in the covering-path set specifying step, and (ii) carrying out the number and direction assigning step, the preliminary wire segment generating step, and the wire pattern determining step in sequence.

4. The method of determining a wire pattern on a board as defined in claim 1, wherein the routes of any one or more of the wires obtained in the wire pattern determining step are altered by (i) setting the pins such that the number of the pins is greater than that of the wires in the area-graph constructing step, and (ii) changing the numbers assigned to the pins, thereby changing the wire pattern.

5. A board designed by the method of determining a wire pattern on a board as defined in claim 1.
